(19) United States
(12) Patent Application Publication
(10) Pub. No.: US 2011/0264534 A1
(43) Pub. Date: Oct. 27, 2011

(54) BEHAVIORAL ANALYSIS DEVICE, BEHAVIORAL ANALYSIS METHOD, AND RECORDING MEDIUM

(76) Inventor: Atsushi Moriya, Tokyo (JP)

(21) Appl. No.: 13/125,494

(22) PCT Filed: Nov. 10, 2009
(86) PCT No.: PCT/JP2009/069117

§ 371 Date: Apr. 21, 2011

(30) Foreign Application Priority Data
Nov. 10, 2008 (JP) 2008-288279

(51) Int. Cl. G06Q 30/00; G06F 17/40

(52) U.S. Cl. 705/14.68

(57) ABSTRACT

A behavioral analysis device for analyzing the behavior of people contacting a plurality of advertising media devices (3a to 3b) comprises a contact history recording unit (7) extracting features of a person viewing advertisement on the advertising media devices (3a to 3c) and recording the features and the time the image is captured for each of the advertising media devices (3a to 3c) and a media pass counting unit (8) analyzing the records of all advertising media devices (3a to 3c) recorded in the contact history recording unit (7) and counting the number of people moving between the advertising media devices (3a to 3c).

### TECHNICAL FIELD

The present invention relates to a behavioral analysis device and method and recording medium for analyzing the behavior of people moving among multiple advertising media devices.

### BACKGROUND ART

Advertising media devices called electronic advertising devices or digital signage are known (for example, Patent Literature 1). An advertising media device has a display means (for example, a liquid crystal display unit), on which advertisement (animated or still images) is displayed to show it to visitors to a store and the like for the purpose of advertising. Here, advertisement is not confined to images presenting products and inviting the customers to purchase them but includes a broader sense of advertisement such as the announcement of promotion events and impression advertising for spreading a brand image.

Demand exists for measuring the effect of advertising using the above advertising media devices for improving the advertising media devices in location and images to be displayed. Patent Literature 1 has proposed a behavioral analysis device cross-checking the features of the face images of people viewing advertisement displayed on an advertising display means placed outside a store with the face images of people who came to the store advertised by the advertisement, counting the number of people who came to the store among the people who viewed the advertisement, and calculating the index of effectiveness of the advertisement based on the results.

### PRIOR ART DOCUMENTS

### Patent Literature

Patent Literature 1: Unexamined Japanese Patent Application KOKAI Publication No. 2005-251170.

### SUMMARY OF INVENTION

### Problem to be Solved by the Invention

The behavioral analysis device of the Patent Literature 1 directly compares the number of people who viewed advertisement displayed on the advertisement display means with the number of people who actually came to the store after they saw the advertisement on a one-to-one basis to calculate the index of effectiveness of the advertisement.

Recently, with expectation for synergetic effect, multiple advertising media devices are placed in a specific area (for example, in a specific facility). Then, there is demand for obtaining information on mutual relations among multiple advertising media devices, such as which advertising media device attracts more people, to which advertising media device the same person repeatedly comes back to see it, and which advertising media device a person who saw a specific advertising media device would come to next, and using the information for improving the advertising media devices in location and contents of advertisement. However, the behavioral analysis device of the Patent Literature 1 cannot fulfill such demand.

The present invention is invented with such a background and an exemplary object of the present invention is to provide a behavioral analysis device, behavioral analysis method, and recording medium for analyzing the behavior of people among advertising media devices and obtaining information useful for improving the advertising media devices in location and the like.

### Means for Solving the Problem

The behavioral analysis device according to the present invention is a behavioral analysis device for analyzing the behavior of people contacting a media cluster comprising a plurality of advertising media devices having a display part displaying an advertisement and an imaging part capturing images of people viewing the advertisement, wherein the behavioral analysis device comprises a media contact history recording part extracting information identifying a person who viewed the advertisement from an image captured by the imaging part, and recording contact history information including information identifying the person, information indicating the time the image is captured, and information identifying the advertising media device displaying the advertisement; and a media pass counting part counting the number of people moving between an advertising media device and another advertising media device based on the contact history information recorded in the media contact history recording part.

The behavioral analysis method according to the present invention is a behavioral analysis method for analyzing the behavior of people contacting a media cluster comprising a plurality of advertising media devices having a display part displaying advertisement and an imaging part capturing images of people viewing the advertisement, wherein the behavioral analysis method has a media contact history recording step of extracting information identifying a person who viewed the advertisement from an image captured by the imaging part, and recording contact history information including information identifying the person, information indicating the time the image is captured, and information identifying the advertising media device displaying the advertisement; and a media pass counting step of counting the number of people moving between an advertising media device and another advertising media device based on the contact history information recorded in the media contact history recording step.

The recording medium according to the present invention records programs that are installed on a computer for analyzing the behavior of people contacting a media cluster comprising a plurality of advertising media devices having a display part displaying advertisement and an imaging part capturing images of people viewing the advertisement so as to allow the computer to function as a media contact history recording part extracting information identifying a person who viewed the advertisement from an image captured by the imaging part, and recording contact history information including information identifying the person, information indicating the time the image is captured, and information identifying the advertising media device displaying the advertisement; and a media pass counting part counting the number of people moving between an advertising media device and another advertising media device based on the contact history information recorded in the media contact history recording part.

### Effect of the Invention

The present invention makes it possible to analyze the behavior of people among advertising media devices and obtain information useful for optimizing the location of advertising media devices and improving the contents of advertisement, such as which advertising media device attracts more people, to which advertising media device the same person repeatedly comes back to see it, and which advertising media device a person who viewed a specific advertising media device would come to next.

### BRIEF DESCRIPTION OF DRAWINGS

FIG. 1 An illustration showing the conceptual configuration of a media cluster;

FIG. 2 An illustration showing the appearance of an advertising media device;

FIG. 3 An illustration showing the conceptual configuration of a behavioral analysis device according to an embodiment of the present invention;

FIG. 4 An illustration showing exemplary symbols of a media cluster displayed on the image display unit;

FIG. 5 An illustration showing exemplary symbols presenting the magnitude of a media touch point;

FIG. 6 An illustration showing exemplary symbols presenting the magnitude of a retouch point;

FIG. 7 An illustration showing an exemplary configuration of the server unit;

FIG. 8 An illustration showing an exemplary structure of schedule information;

FIG. 9 An illustration showing an exemplary structure of advertising video image information;

FIG. 10 An illustration showing an exemplary structure of contact history information;

FIG. 11A flowchart for explaining the operation of the behavioral analysis device;

FIG. 12 A flowchart for explaining the analysis operation of the behavioral analysis device;

FIG. 13 An illustration showing the conceptual configuration of a behavioral analysis device according to another embodiment of the present invention;

FIG. 14 An illustration showing an exemplary symbol presenting the magnitude of a cluster pass; and

FIG. 15 An illustration showing an exemplary symbol presenting the magnitude of a cluster pass.

### BEST MODE FOR CARRYING OUT THE INVENTION

The best mode for carrying out the present invention is described hereafter.

Here, embodiments are given for easy understanding of the principles of the present invention and the scope of the present invention is not confined to the embodiments below. Other embodiments in which some components of the embodiments below are replaced as appropriate by a person of ordinary skill in the field also fall under the scope of the present invention.

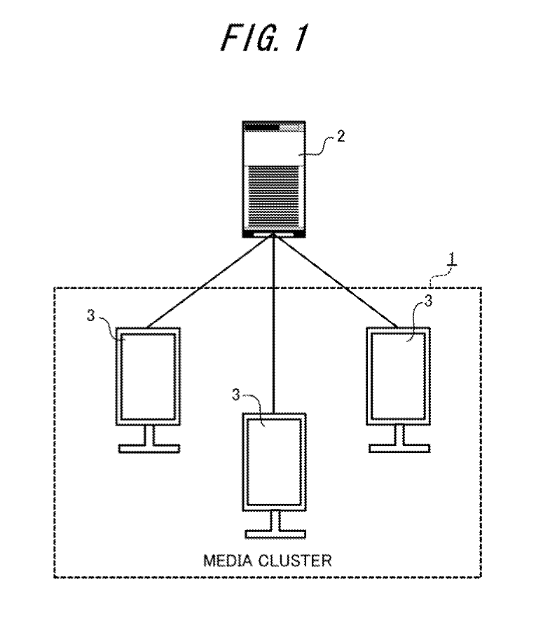

FIG. 1 is an illustration showing the conceptual configuration of a media cluster 1 to be analyzed by a behavioral analysis device according to an embodiment of the present invention.

As shown in FIG. 1, a media cluster 1 is composed of three advertising media devices 3. The media cluster 1 is connected to a server unit 2.

The server unit 2 is a computer comprising a medium on which advertising video images are recorded, distributing the advertising video images read from the medium to the advertising media devices 3 according to given programs, and analyzing data (described in detail later) sent from the advertising media devices 3.

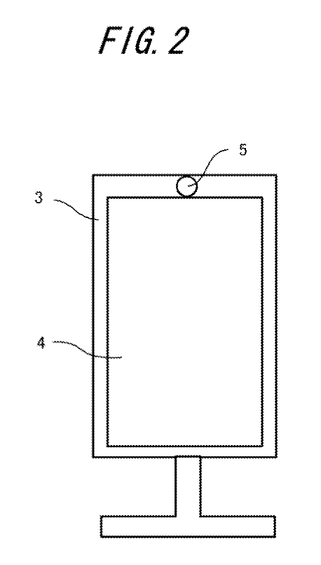

FIG. 2 is an illustration showing the appearance of an advertising media device 3. The advertising media device 3 is an electronic advertising device having a liquid crystal image display unit 4 and a camera 5. Advertising video images distributed from the server unit 2 are displayed on the liquid crystal image display unit 4. The camera 5 captures images of people who are viewing the advertising video images on the liquid crystal image display unit 4.

The server unit 2 stores advertising video images and distributes the advertising video images to the advertising media devices 3 according to a given schedule for display. Furthermore, the server unit 2 receives images from the cameras 5 of the advertising media devices 3, accumulates information on customers having contacted the advertising media devices 3, and analyzes the accumulated information to count the number of customers moving between the advertising media devices 3.

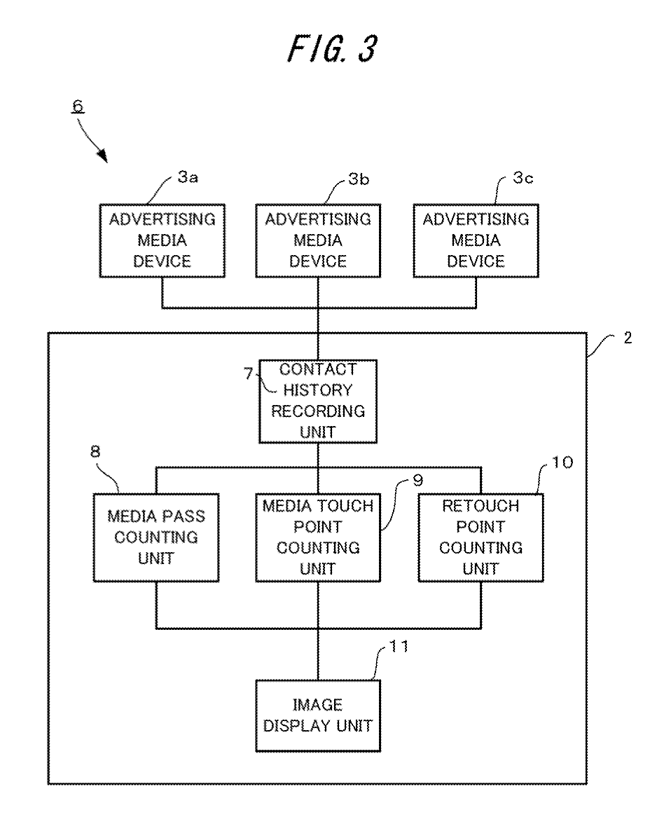

FIG. 3 is an illustration showing the conceptual configuration of a behavioral analysis device 6 according to an embodiment of the present invention. The behavioral analysis device 6 is composed of three advertising media devices 3 (distinguished from each other by suffixes a, b, and c where necessary and other components are similarly distinguished hereafter) and a server unit 2 connected to them.

The server unit 2 comprises a contact history recording unit 7, a media pass counting unit 8, a media touch point counting unit 9, a retouch point counting unit 10, and an image display unit 11.

The contact history recording unit 7 extracts features of a person in the images captured by the cameras 5 of the advertising media devices 3 and stores information (which is occasionally termed “contact history information” hereafter) including information on the features of the person (for example, a face image), identification information of the advertising media devices 3 the person was viewing, the time the image was captured, and information identifying the advertising video image displayed at the time.

The media pass counting unit 8 counts the number of people moving between the advertising media devices 3 (for example, between the advertising media devices 3a and 3b) (“the media pass” in this embodiment). For example, if a person X viewed an advertising video image on the advertising media device 3a and then moved to the advertising media device 3b, the media pass between the advertising media devices 3a and 3b is increased by “1.” If persons X and Y move between the advertising media devices 3a and 3b, the media pass is increased by “2.” Even if the same person repeatedly moves between the same two devices, the media pass is increased. For example, if a person X moves from the advertising media device 3a to the advertising media device 3b and then, returns to the advertising media device 3a (in other words, goes and come back), the media pass is increased by “2.”

The media pass is counted by analyzing the contact history information recorded in the contact history recording unit 7. A person who has a specific feature is assumed to be a person X. The contact history information having the same feature as the person X is extracted from the contact history recording unit 7 and arranged in chronological order. Then, the history of move of the person X is revealed. For example, if the person X is in an image captured by the advertising media device 3c (the camera 5c) immediately after he/she was imaged by the advertising media device 3b (the camera 5b), it is known that the person X moved between the advertising media devices 3b and 3c during that time. Then, the media pass between the advertising media devices 3b and 3c is increased by “1.”

The media touch point counting unit 9 counts the total number of people who contacted the advertising media devices 3 (in other words those who viewed advertising video images on the advertising media devices 3) for each of the advertising media devices 3a to 3c (“the media touch point” in this specification).

The media touch point is counted by analyzing the contact history information recorded in the contact history recording unit 7. The media touch point indicates the total number of people. For example, if a person X contacted the advertising media device 3a three times, the media touch point is increased by “3.”

The retouch point counting unit 10 counts the total number of times people who had viewed advertisement on an advertising media device 3 viewed the advertisement again for each of the advertising media devices 3a to 3b (“the retouch point” in this specification).

The retouch point is counted by analyzing the contact history information recorded in the contact history recording unit 7. For example, if persons X, Y, and Z contacted the advertising media device 3a three times, two times, and one time, respectively, the retouch point of the advertising media device 3a is “3 (=2+1+0).”

The image display unit 11 graphically displays the analysis results by the behavioral analysis device 6, namely the media pass, media touch point, and retouch point.

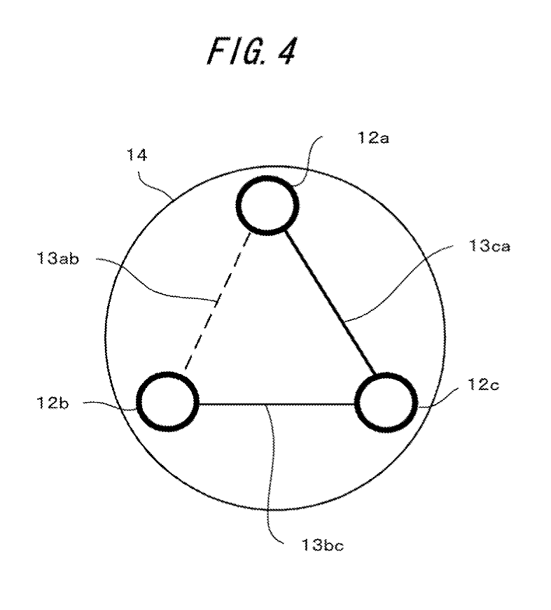

For example, the image display unit 11 displays the media cluster 1 shown in FIG. 1 using symbols as shown in FIG. 4.

In FIG. 4, nodes 12 (12a to 12c) are symbols presenting the advertising media devices 3 (3a to 3c). The media passes 13ab, 13bc, and 13ca are presented by line segments joining the nodes 12a to 12c. The range of the media cluster 1 is presented by a circle 14. The nodes 12a to 12c within the circle 14 indicate that the advertising media devices 3a to 3c belong to the media cluster 1.

The magnitude of a media pass is indicated by the thickness of the line segments 13ab, 13bc, and 13ca. For example, the media pass 13ab between the nodes 12a and 12b (the advertising media devices 3a and 3b) is presented by a dotted line, indicating that the media pass 13ab has a magnitude of “0.” The media pass 13bc between the nodes 12b and 12c is presented by a thin line and the media pass 13ca between the nodes 12c and 12a is presented by a thick line, indicating that the media passes 13bc and 13ca have a magnitude of “1” and “2,” respectively.

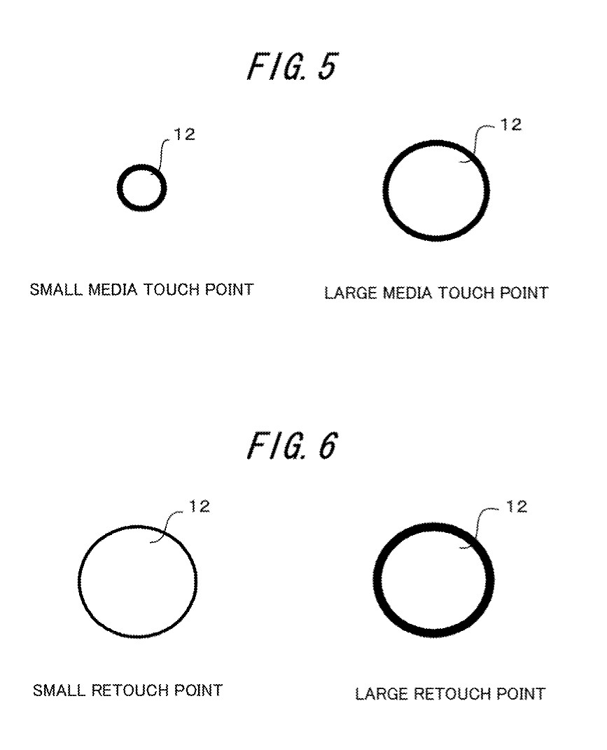

As shown in FIG. 4, the nodes 12 are each presented by a ring-shaped graphic symbol. The magnitudes of the media touch point and retouch point are presented by the size of the node 12. In other words, the magnitude of the media touch point is presented by the diameter of the outer circle of the node 12 and the magnitude of the retouch point is presented by the diameter of the inner circle of the node 12. As shown in FIG. 5, the node 12 is presented by a larger ring as the media touch point is increased. Furthermore, as shown in FIG. 6, the node 12 is presented by a thicker ring as the retouch point is increased.

As described above, the behavioral analysis device 6 automatically detects the moves of people moving between the advertising media devices 3a to 3c and displays them in easily understandable graphics, whereby the relations between the advertising media devices 3a to 3c and locational merit/demerit can be evaluated.

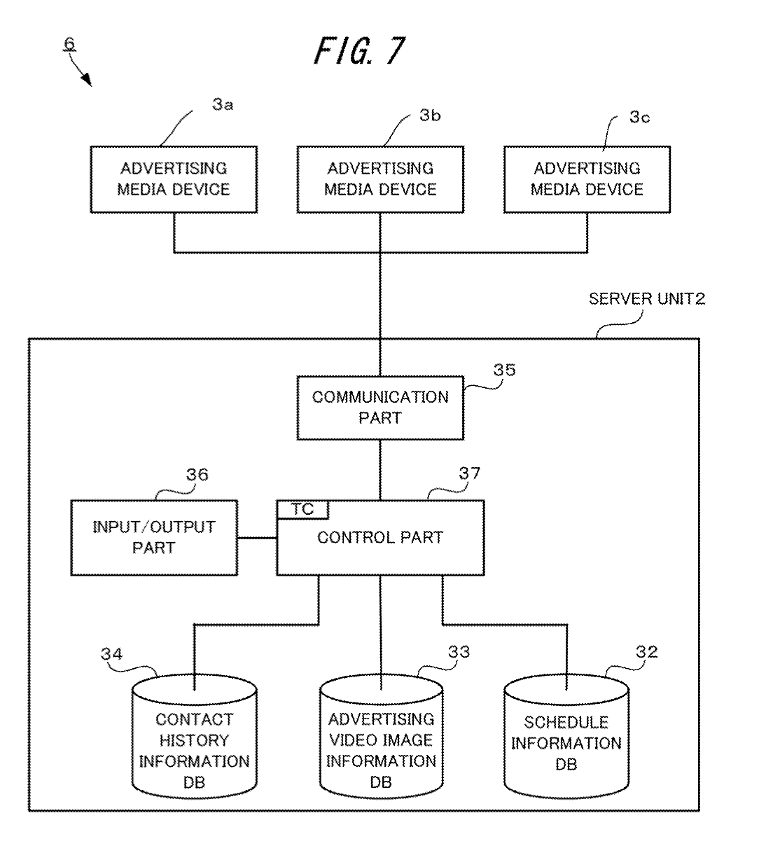

The server unit 2 physically comprises, as shown in FIG. 7, a schedule information database (DB) 32, an advertising video image information DB 33, a contact history information DB 34, a communication part 35, an input/output part 36, and a control part 37.

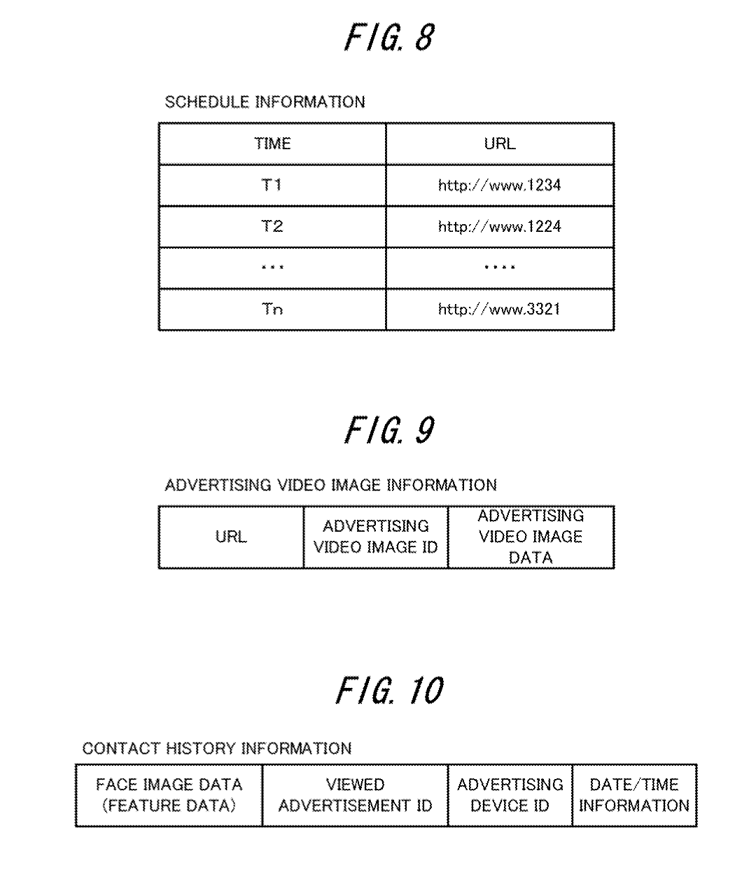

The schedule information DB 32 stores advertisement distribution (display) schedule for each advertising media device 3. FIG. 8 is an illustration showing an exemplary structure of the schedule information stored in the schedule information DB 32. The distribution schedule includes, as shown in FIG. 8, times (hour, minute, second) and storage position addresses (URL: uniform resource locator) of advertising video images (for example, animated images with sound) to be displayed.

The advertising video image information DB 33 stores video image date (for example, MPEG format animated images with sound) of advertising video images to be displayed. FIG. 9 is an illustration showing an exemplary structure of the advertising video image information stored in the advertising video image DB 33. Each video image data constituting advertising video image information are identified by an URL as shown in FIG. 9.

The distribution schedule identifies video image data to distribute by the URL. Each advertising video image has an ID (video image ID).

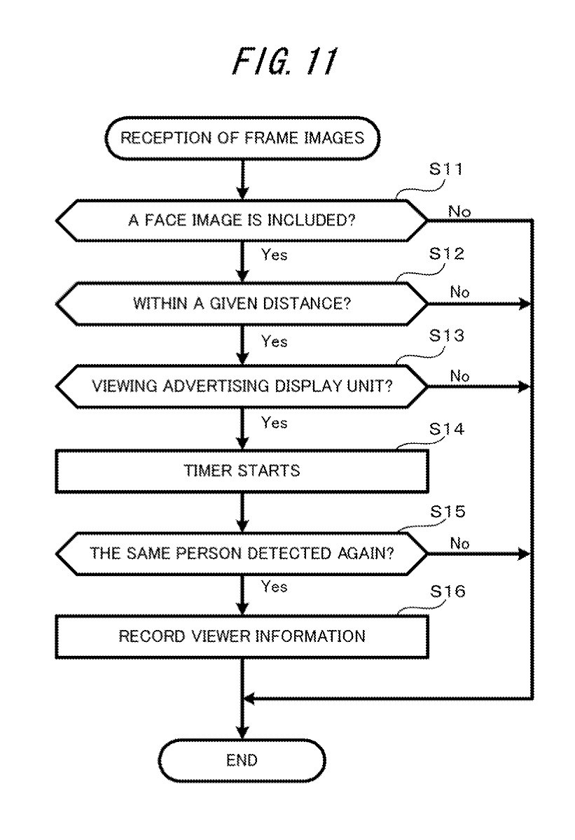

The contact history information DB 34 stores contact history information identifying a person who viewed an advertising video image displayed on an advertising media device 3 and the viewed advertising video image. FIG. 10 is an illustration showing an exemplary structure of the contact history information stored in the contact history information DB 34. The contact history information includes, as shown in FIG. 10, image data of a face image of a person who viewed an advertising video image displayed on an advertising media device 3 (face image data), identification information of the advertising video image viewed by the person (viewed advertisement ID), identification information of the advertising media device 3 (advertising device ID), and date/time information indicating the date and time the advertisement was viewed. The contact history information may further include face feature data extracted from the image data.

The communication part 35 communicates with the advertising media devices 3 via communication networks.

The input/output part 36 is composed of a keyboard, a mouse, and a display unit. It is used to enter various instructions and data into the control part 37 and display output from the control part 37.

Composed of a processor or the like, the control part 37 comprises a timer TC and operates according to control programs. More specifically, the control part 37 reads advertising video images to be displayed on the advertising media devices 3 from the advertising video image information DB 33 according to the distribution schedule registered in the schedule information DB 32 and supplies them through the communication part 35 via communication lines. Furthermore, the control part 37 edits and updates the distribution schedule in response to instructions through the input/output part 36.

Furthermore, the control part 37 associates face images captured by the cameras 5 of the advertising media devices 3 with the identification information of the advertising video images displayed at the time of the face images being captured and records them in the contact history information DB 34.

Operation of the behavioral analysis device 6 having the above configuration will be described hereafter.

First, the control part 37 of the server unit 2 reads an advertising video image to be displayed from the advertising video image information DB 33 according to the current time timed by the timer TC and the schedule registered in the schedule information DB 32 and supplies it to the advertising media devices 3a to 3c. The advertising media devices 3a to 3c display the supplied advertising video image.

On the other hand, the cameras 5a to 5c installed in the advertising media devices 3a to 3c capture images of the view in front of them, acquire frame images in a frame cycle of, for example, 1/30 second, and send them to the server unit 2.

Receiving the frame images from the cameras 5a to 5c installed in the advertising media devices 3a to 3c, the control part 37 of the server unit 2 processes the received frame images as shown in FIG. 11.

The following explanation will be made with respect to frame images received from the camera 5 installed in the advertising media device 3a.

First, the control part 37 determines whether any face image is included in the supplied frame images using a pattern recognition technique (Step S11). In Step S11, any pattern recognition technique can be used as long as it can be determined whether any face image is included in the images (frame images) captured by the camera 5.

When a face image is included (Step S11: Yes), the control part 37 determines whether the person is within a given distance from the advertising media device 3a (Step S12). If he/she is within a given distance (Step S12: Yes), the control part 37 determines whether the person is viewing (paying attention to) the advertising media device 3a (Step S13).

Whether the person is within a given distance from the advertising media device 3a can be determined, for example, by determining whether the face size on the frame image is equal to or larger than a reference value. Alternatively, for example, an infrared distance sensor may be used to determine whether the distance between a person and the advertising media device 3a is equal to or smaller than a given distance.

Whether the person is viewing the advertising media device 3a can be determined, for example, by determining whether a pair of two black dots (presumably eye images) at a given distance (10 to 18 cm) can be extracted in the face image.

The control part 37 ends the current process when no face image is included in the received frame images (Step S11, No), when the person is at a given distance or more away from the advertising media device 3a (Step S12: No), or when the person is not viewing (paying attention to) the advertising media device 3a (Step S13: No).

On the other hand, when it is determined in Step S13 that the person is viewing the advertising media device 3a (Step S13: Yes), the control part 37 starts (activates) the timer TC (Step S14). The timer measures the time and, after a given period of time, the procedure of Step S15 described later will be executed.

After a given period of time has elapsed, the control part 37 determines whether the camera 5 installed in the advertising media device 3a detects the same person (Step S15).

If the camera 5 installed in the advertising media device 3a does not detect the same person after a given period of time has elapsed or when the time is up (Step S15: No), in other words if the person left the advertising media device 3a before the given period of time has elapsed, the process ends with no further procedure. On the other hand, if the camera 5 continues to detect the same person, in other words if the same person stays in front of the advertising media device 3a for a given period of time to view the advertising video image 3a (Step S15: Yes), the control part 37 records a face image of the person captured by the camera 5 (a new face image), the ID of the advertising video image displayed on the advertising media device 3a at the time (the advertising video image ID), and the identification code of the advertising media device 3a (the advertising device ID) in the contact history recording unit 7 (physically in the contact history information DB 34) (Step S16).

Here, in Step S16, it is possible that the contact history information is not updated if the same face image is found with the same advertising video image on the same electronic advertising device, in other words a person stays in front of the advertising media device 3a and continues to view the advertising video image, and that the contact history information is updated by rewriting or addition only when there is any information change.

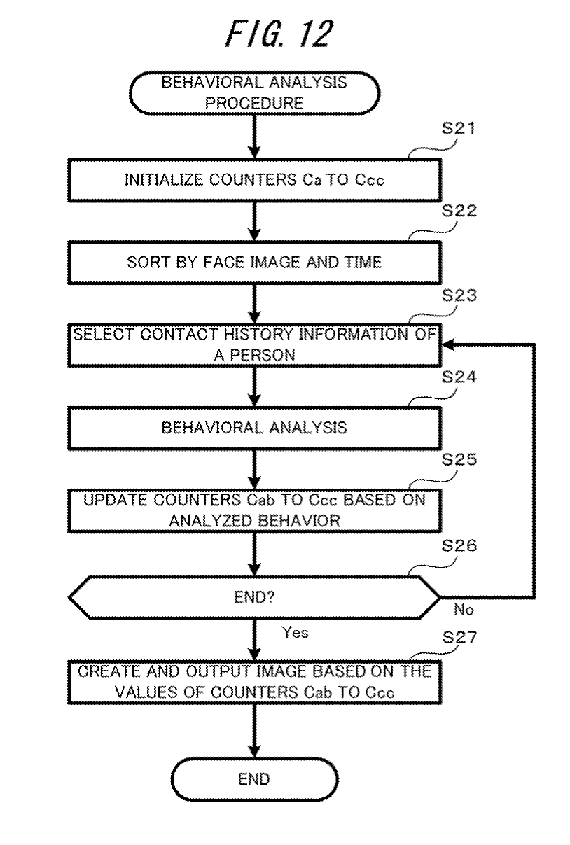

A procedure of analyzing the contact history information accumulated as described above (the behavioral analysis procedure) will be described hereafter with reference to the flowchart in FIG. 12.

The user or the administrator of the behavioral analysis device 6 gives an instruction through the input/output part 36 to analyze the accumulated contact history information. In response to the instruction, the control part 37 starts the behavioral analysis procedure shown in FIG. 12.

First, the control part 37 initializes a counter Ca indicating the number of touches to the advertising media 3a, a counter Cb indicating the number of touches to the advertising media 3b, a counter Cc indicating the number of touches to the advertising media 3c, a counter Cab indicating the number of moves between the advertising media 3a and 3b, a counter Cbc indicating the number of moves between the advertising media 3b and 3c, a counter Cca indicating the number of moves between the advertising media 3c and 3a, a counter Caa indicating the number of retouches to the advertising media 3a, a counter Cbb indicating the number of retouches to the advertising media 3b, and a counter Ccc indicating the number of retouches to the advertising media 3c (Step S21).

Here, the counters Ca, Cb, and Cc correspond to the above-described media touch points. The counters Cab, Cbc, and Cca correspond to the above-described media passes. The counters Caa, Cbb, and Ccc correspond to the above-described retouch points.

Then, the control part 37 sorts the contact history information stored in the contact history information DB 34 by the face image data (the first key) and date/time information (the second key) (Step S22). Consequently, the contact history information is sorted by person and by time.

Then, the control part 37 selects a person (face image) in the sorted contact history information (Step S23) and obtains the behavior of the person (the history of move among the advertising media devices 3) based on the selected contact history information (Step S24).

The contact history information is sorted by time in Step S22. Therefore, by tracking the advertising device ID included in the contact history information, the control part 37 is able to find the history of moves among the advertising media devices 3.

Then, the control part 37 updates the counters based on the obtained history of move (Step S25).

For example, it is assumed that a person is found to have a history of move: “the advertising media device 3a→the advertising media device 3b→the advertising media device 3a.” In such a case, the control part 37 increments the counter Ca by 2, the counter Cb by 1, the counter Cab by 2, and the counter aa by 1.

Subsequently, the control part 37 determines whether the entire viewer history information is analyzed (Step S26). If there is any unfinished face image (Step S26: No), the viewer history information for the next person is selected (Step S23) and similarly analyzed.

On the other hand, if the entire viewer history information has been analyzed (Step S26: Yes), the control part 37 generates a display image based on the values of the counters and outputs (displays) it to (on) the image display unit 11 (Step S27). Then, the behavioral analysis procedure ends.

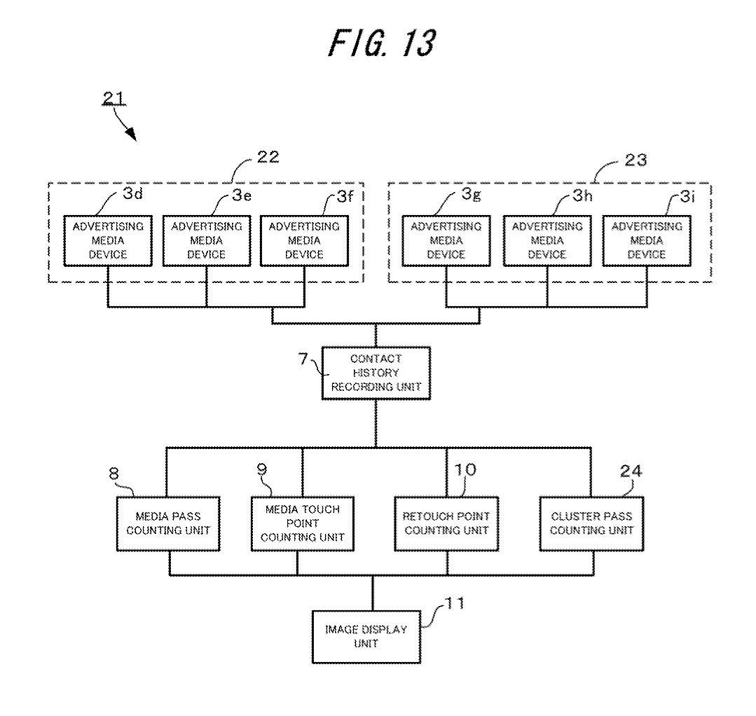

FIG. 13 shows a behavioral analysis device capable of detecting moves of people between multiple media clusters.

As shown in FIG. 13, a behavioral analysis device 21 comprises advertising media devices 3d to 3f belonging to a first media cluster 22, advertising media devices 3g to 3i belonging to a second media cluster 23, a contact history recording unit 7, a media pass counting unit 8, a media touch point counting unit 9, a retouch point counting unit 10, and an image display unit 11, and additionally a cluster pass counting unit 24.

The contact history recording unit 7, media pass counting unit 8, media touch point counting unit 9, and retouch point counting unit 10 are provided to count the media pass, media touch point, and retouch point of each of the first and second media clusters 22 and 23. They are basically the same as the contact history recording unit 7, media pass counting unit 8, media touch point counting unit 9, and retouch point counting unit 10 of the behavioral analysis device 6 described above.

The cluster pass counting unit 24 counts the cluster pass, namely the number of people moving between the first and second media clusters 22 and 23 (the cluster pass). More specifically, the cluster pass counting unit 24 cross-checks the contact history information belonging to the first media cluster 22 and the contact history information belonging to the second media cluster 23, which are recorded in the contact history recording unit 7, and counts the number of people common to the two clusters as the cluster pass.

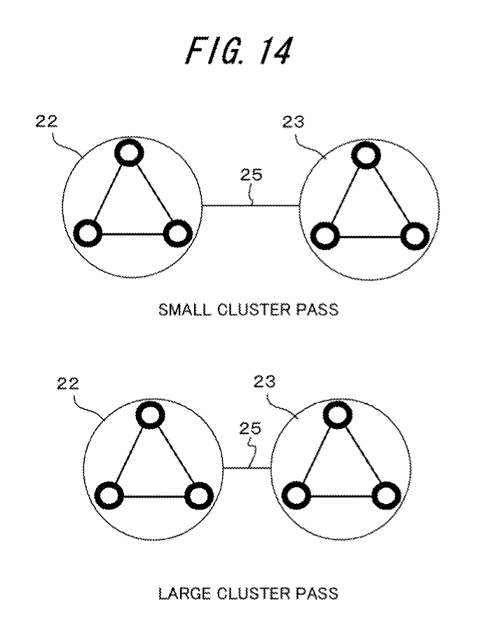

On the image display unit 11, the cluster pass is presented by a line segment connecting the symbols presenting two media clusters. More specifically, as shown in FIG. 14, a line segment 25 is shorter when there are many people moving between the first and second clusters 22 and 23 than when there are a few people. In other words, the media clusters are positioned closer to each other when the cluster pass is larger in magnitude. In this way, it can be instantly understood that there is a close relation between them.

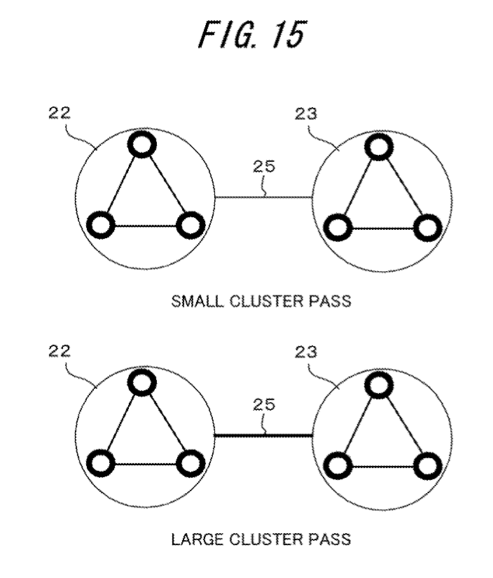

Here, as shown in FIG. 15, the cluster pass can be presented by the thickness of a line segment connecting the symbols presenting two media clusters. More precisely, the line segment connecting two media clusters is thicker as the cluster pass is larger in magnitude. In this way, it can also be instantly understood that there is a close relation between them.

The above behavioral analysis device 21 can be used, for example, in a department store, wherein each department constitutes a media cluster and the cluster passes are measured. Then, it can instantly be understood what customer groups are common to or related between which departments, which is useful in improving the layout of departments.

For such analysis, in the behavioral analysis procedure shown in FIG. 12, a counter obtaining the number of moves between clusters is prepared and the counter is updated based on the analysis results in Step S25.

In this embodiment, a media cluster consists of “a set of advertising media devices 3 controlled by one server unit 2” by way of example. The media cluster of the present invention is not restricted to the above-described one. The media cluster is a set of advertising media devices 3 provided as targets for measuring the media pass. It is not a requirement for the media cluster to use a common server unit 2.

For convenience of explanation, the contact history recording unit 7, media pass counting unit 8, media touch point counting unit 9, retouch point counting unit 10, image display unit 11, and cluster pass counting unit 24 are configured by one server 2. However, the behavioral analysis device of the present invention is not confined to such a configuration. They can be realized by multiple devices.

If the server unit 2 has an auxiliary image display unit, it can be used as the image display unit 11. Needless to say, a dedicated computer to the behavioral analysis device can be used.

The camera 5 can capture an image of not only the face of a person but also any part of a person such as the upper body and entire body. Furthermore, the camera 5 can comprise a motion sensor, heat sensor, or infrared sensor. When such a sensor detects a person, the camera carrying that sensor is activated to capture an image of the person. Furthermore, the camera 5 may capture still images at any time intervals (for example, every three seconds). The control part 37 may spot a customer based on multiple still images captured.

The present application claims the priority based on the Japanese Patent Application No. 2008-288279, the entire specification, scope of claims, and drawings of which are incorporated herein by reference.

Legend
1 media cluster
2 server unit
3 advertising media device
4 liquid crystal image display unit
5 camera
6 behavioral analysis device
7 contact history recording unit
8 media pass counting unit
9 media touch point counting unit
10 retouch point counting unit
11 image display unit
12 node
13 media pass
14 circle
21 behavioral analysis device
22 first media cluster
23 second media cluster
24 cluster pass counting unit
25 line segment

1. A behavioral analysis device for analyzing the behavior of people contacting a media cluster comprising a plurality of advertising media devices having a display part displaying advertisement and an imaging part capturing images of people viewing said advertisement, wherein said behavioral analysis device comprises:
a media contact history recording part extracting information identifying a person who viewed said advertisement from an image captured by said imaging part, and recording contact history information including information identifying the person, information indicating the time the image is captured, and information identifying said advertising media device displaying the advertisement; and
a media pass counting part counting the number of people moving between an advertising media device and another advertising media device based on the contact history information recorded in said media contact history recording part.

2. The behavioral analysis device according to claim 1, comprising a media touch point counting part counting the total number of people viewing the advertisement displayed by the advertising media devices for each of said advertising media devices based on the contact history information recorded in said media contact history recording part.

3. The behavioral analysis device according to claim 2, comprising a retouch point counting part counting the total number of times people who had viewed advertisement displayed by the advertising media devices viewed the advertisement again for each of said advertising media devices based on the contact history information recorded in said media contact history recording part.

4. The behavioral analysis device according to claim 1, analyzing the behavior of people contacting a plurality of media clusters; and
comprising a cluster pass counting part counting the number of people common to two media clusters by comparing the contact history information of advertising media devices belonging to one media cluster with the contact history information of advertising media devices belonging to the other media cluster.

5. The behavioral analysis device according to claim 1, comprising an image display part displaying said advertising media devices by ring-shaped symbols and the number of people moving between said advertising media devices by the thickness of a line segment connecting said ring-shaped symbols.

6. The behavioral analysis device according to claim 2, comprising an image display part displaying said advertising media devices by ring-shaped symbols and the total number of people viewing advertisement displayed by said advertising media devices by the diameter of the outer circle of said ring-shaped symbols.

7. The behavioral analysis device according to claim 3, comprising an image display part displaying said advertising media devices by ring-shaped symbols and the total number of times people who had viewed advertisement displayed by said advertising media devices viewed the advertisement again by the diameter of the inner circle of said ring-shaped symbols.

8. The behavioral analysis device according to claim 5, comprising an image display part displaying the number of people common to two media clusters by the length of a line segment connecting the symbols presenting said two media clusters.

9. The behavioral analysis device according to claim 8, wherein said image display part shortens the line segment connecting the symbols presenting said media clusters as the number of people common to said two media clusters increases.

10. The behavioral analysis device according to claim 5, comprising an image display part displaying the number of people common to two media clusters by the thickness of a line segment connecting the symbols presenting said two media clusters.

11. A behavioral analysis method for analyzing the behavior of people contacting a media cluster comprising a plurality of advertising media devices having a display part displaying advertisement and an imaging part capturing images of people viewing said advertisement, wherein said behavioral analysis method has:
a media contact history recording step of extracting information identifying a person who viewed said advertisement from an image captured by said imaging part, and recording contact history information including information identifying the person, information indicating the time the image is captured, and information identifying said advertising media device displaying the advertisement; and
a media pass counting step of counting the number of people moving between an advertising media device and another advertising media device based on the contact history information recorded in said media contact history recording step.

12. A computer-readable recording medium in which recorded are programs that are installed on a computer for analyzing the behavior of people contacting a media cluster comprising a plurality of advertising media devices having a display part displaying advertisement and an imaging part capturing images of people viewing said advertisement so as to allow the computer to function as:
a media contact history recording part extracting information identifying a person who viewed said advertisement from an image captured by said imaging part, and recording contact history information including information identifying the person, information indicating the time the image is captured, and information identifying said advertising media device displaying the advertisement; and
a media pass counting part counting the number of people moving between an advertising media device and another advertising media device based on the contact history information recorded in said media contact history recording part.
